(19) United States
(12) Patent Application Publication
(10) Pub. No.: US 2017/0328088 A1
(43) Pub. Date: Nov. 16, 2017

(54) APPARATUS FOR SECURING TWO MEMBERS TOGETHER

(71) Applicants: Roger Ian CHANTLER, Cradley Heath, West Midlands (GB); Ian SOUTHALL, Wolverley, Warwickshire (US)

(72) Inventors: Roger Ian CHANTLER, Cradley Heath, West Midlands (GB); Ian SOUTHALL, Wolverley, Warwickshire (US)

(73) Assignee: FULLEX LOCKS LIMITED, Kingswinford, West Midlands (GB)

(21) Appl. No.: 15/529,198

(22) PCT Filed: Nov. 18, 2015
(86) PCT No.: PCT/GB2015/000301

§ 371 Date: May 24, 2017

(30) Foreign Application Priority Data
Nov. 28, 2014 (GB) 1421124.7
Oct. 2, 2015 (GB) 1517431.1
Oct. 16, 2015 (GB) 1518394.0

(51) Int. Cl. E05B 65/08; E05C 9/18; E05C 7/00; E05B 17/20

(52) U.S. Cl. CPC E05B 65/0858; E05C 9/1808; E05C 9/1875; E05B 17/2088; E05C 7/00; E05B 65/0835; E05C 2007/007

(57) ABSTRACT

An apparatus is provided for securing together two members which are slidable towards and away from each other to provide a respective open and closed (locked) mode, wherein a plurality of devices are adapted to secure the members in a closed mode, and a control unit is adapted to operate the devices. The devices are in the embodiments described spaced longitudinally apart along a vertical edge or stile of a closure member, which may be a patio door, window, or other closure, with the control unit being disposed intermediate the devices and being operatively linked thereto by a connecting device for actuating the devices. The control unit may be driven manually by a control handle, by a solenoid, by an electric or electro-mechanical motor device, or by spring-loaded interlocking devices. The devices cooperate with keeper devices for securing the closure members together in the closed (locked) mode.

The invention relates to apparatus for securing two members together, and particularly to such apparatus for securing two relatively slidable members such as patio doors together.

As is known, patio doors are a popular means of gaining access from a dwelling to an outside area such as a patio or garden. Generally there are two doors, mounted in a set of respective runners in generally the same plane so that in a closed position or mode, facing edges or stiles of the two doors butt up against one another. At least one of the doors can be slid from a closed or locked position or mode in which a door opening is closed by both doors, to an open position or mode in which the one door is slid away from the other so that the door opening is open for passage therethrough. Generally too, both doors are slid towards and away from one another in the closed and open modes. Often there is a lock to lock the two doors together in the closed mode. Prior doors are unfortunately generally vulnerable to forced entry.

As is also generally known, such a patio door is located in a top, in use, substantially horizontal frame section of the door frame. There is an interaction between a locating groove along a top of the door and a mating upstand on the frame. This area between the groove and upstand is also vulnerable to attack, as the junction can be disengaged by the application of force to the top of the door, particularly at its trailing edge.

It is an object of the invention to seek to mitigate these disadvantages.

According to the invention, there is provided apparatus for securing together two members which are slidable towards and away from each other to provide a respective open and closed mode, comprising a plurality of devices adapted to secure the members in a closed mode and a control unit adapted to operate the devices.

There may be in a preferred embodiment two spaced apart securing devices operable by a single control unit.

According to a second aspect of the invention, there is provided a slidable closure member in combination with apparatus as defined in the immediately preceding paragraph.

It will be understood that the invention extends to a building construction incorporating a slidable closure member as defined in the immediately preceding paragraph.

Apparatus for providing security for a slidable closure member such as a patio door having lockable means and being adapted to slide in a frame to provide a respective open and closed, locked, mode, is hereinafter described, by way of example, in the accompanying drawings.

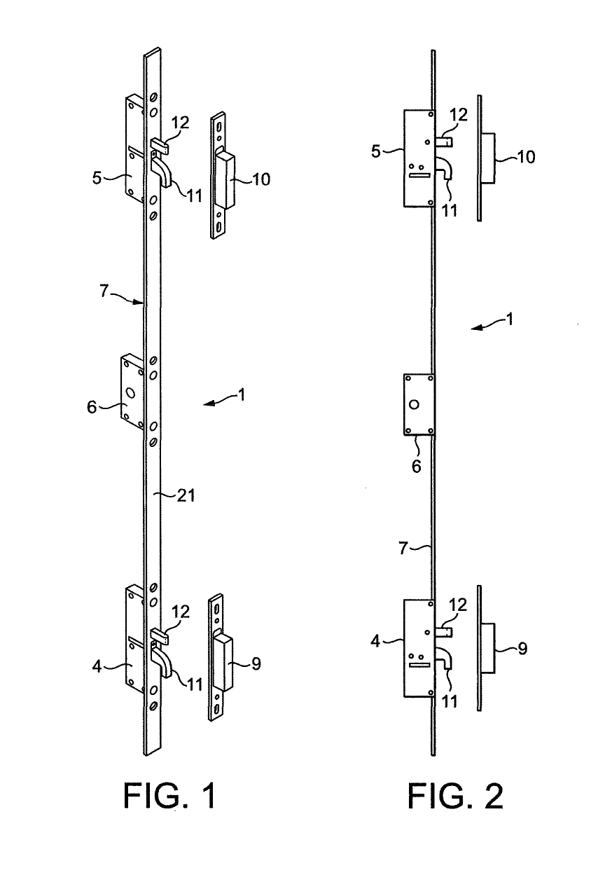

FIG. 1 is a schematic perspective view of apparatus according to the invention;

FIG. 2 is a schematic side elevation view of the apparatus of FIG. 1;

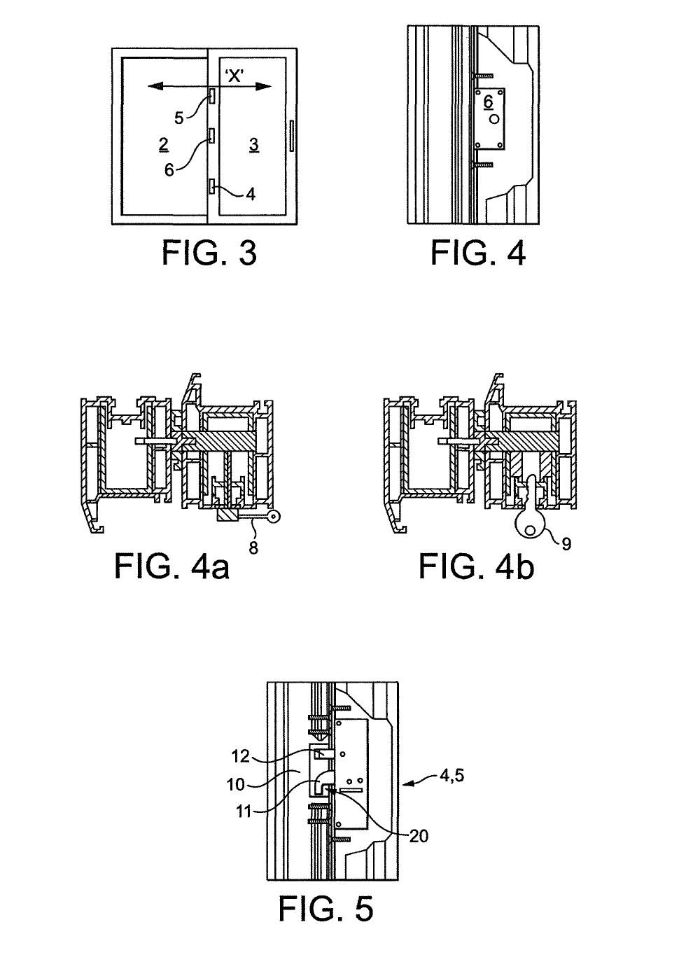

FIG. 3 is a schematic elevational view of an arrangement of two patio doors to a smaller scale than FIGS. 1 and 2, with the position of the apparatus according to the invention shown;

FIGS. 4, 4a and 4b show schematic views of a control unit, FIG. 4a showing it lever operated and FIG. 4b showing it key-operated;

FIG. 5 shows schematically an internal view of a securing device;

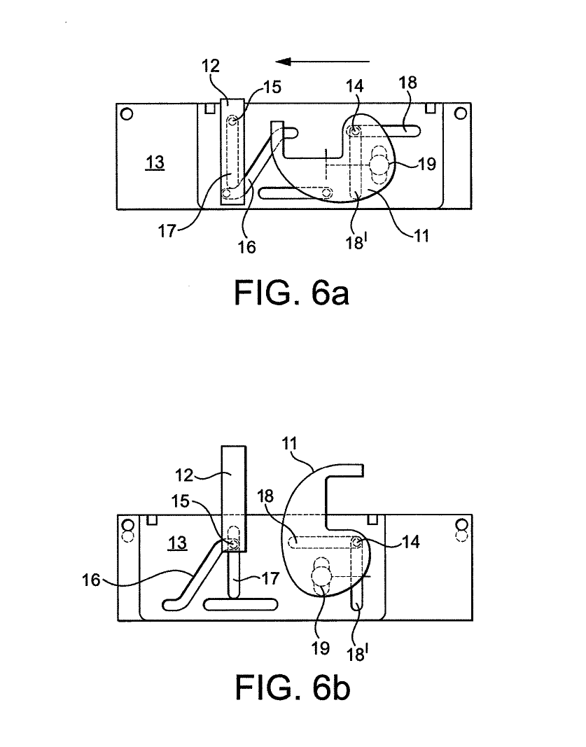

FIGS. 6a and 6b show schematic views of the internal mechanism of the securing device in the retracted and extended position of a hook-like member and an anti-lift device;

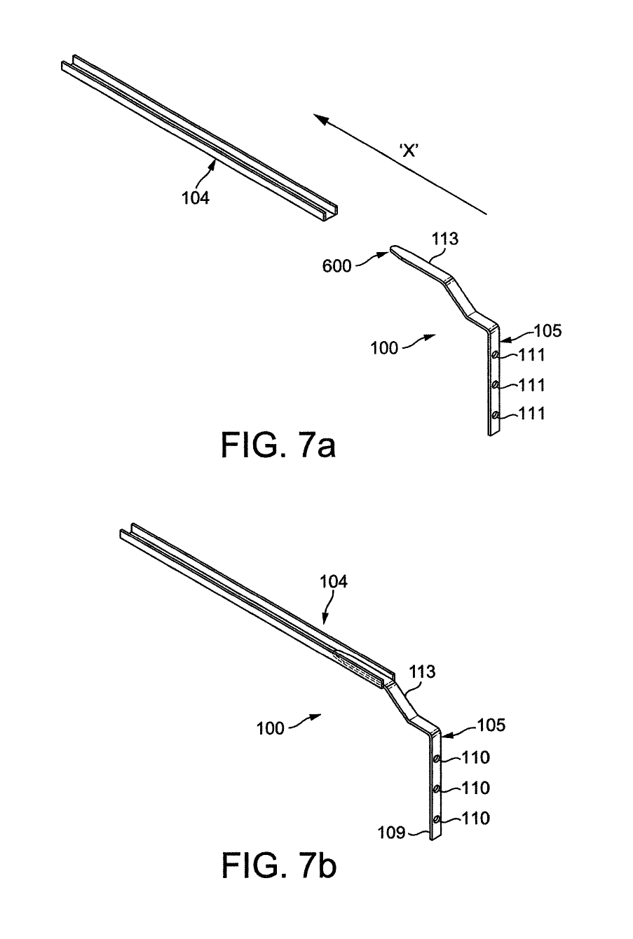

FIG. 7A shows a schematic perspective view of the apparatus in an open mode of the door;

FIG. 7B shows a schematic perspective view of the apparatus of FIG. 1A in a closed position of the door;

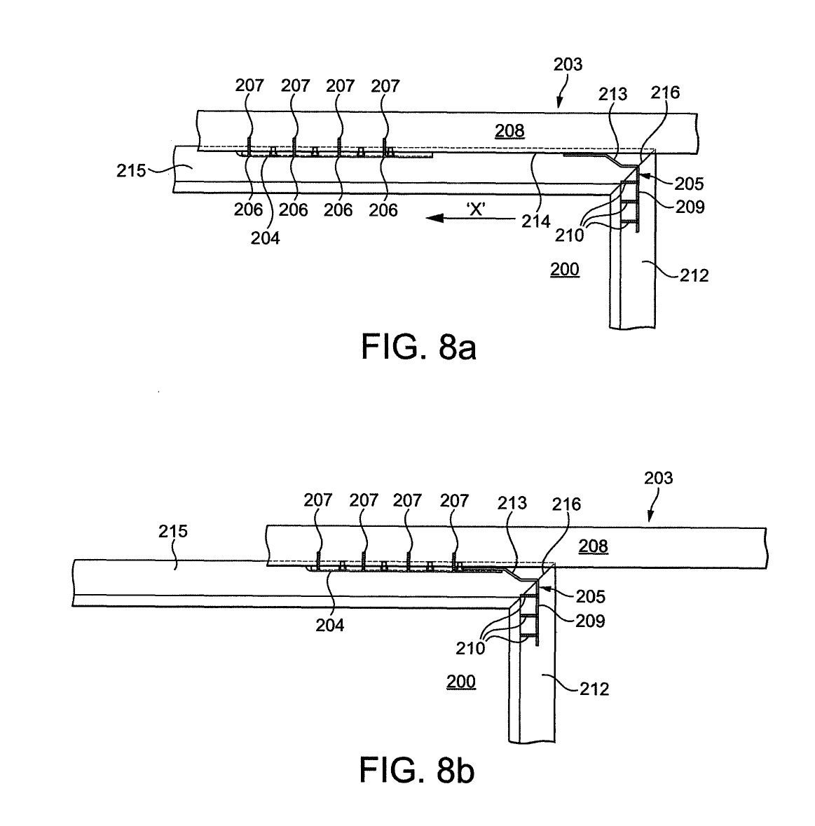

FIGS. 8A and 8B show schematic side elevational views respectively an arrangement of the apparatus of FIGS. 7A and 7B in relation to a door frame;

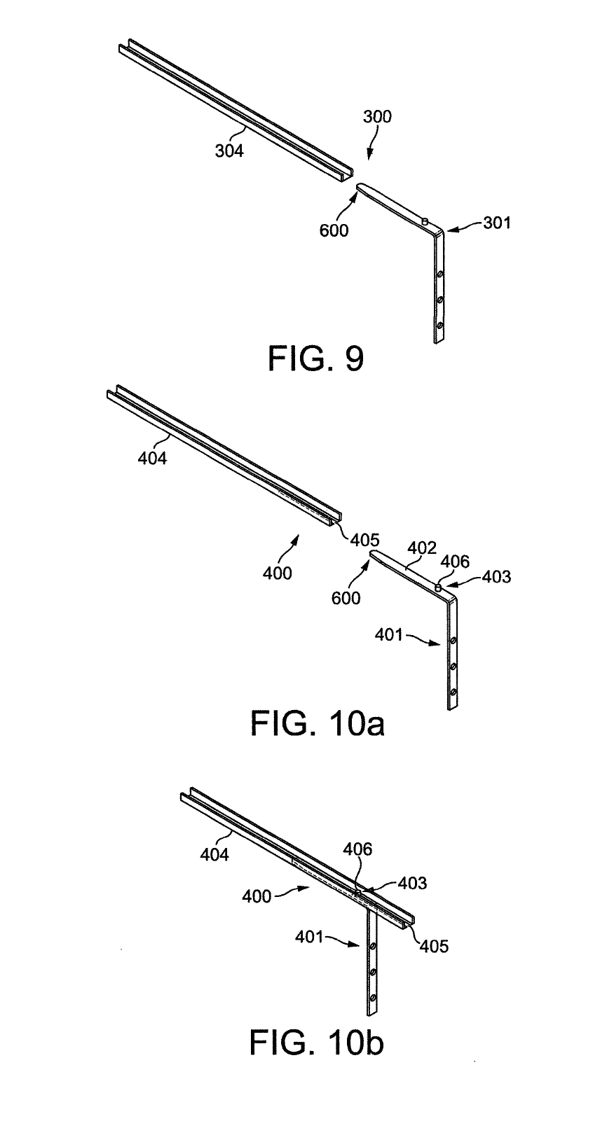

FIG. 9 is a schematic perspective view of a second embodiment of apparatus embodying the invention;

FIGS. 10A and 10B show respective views similar to those of FIGS. 7A and 7B, of a third embodiment of apparatus embodying the invention;

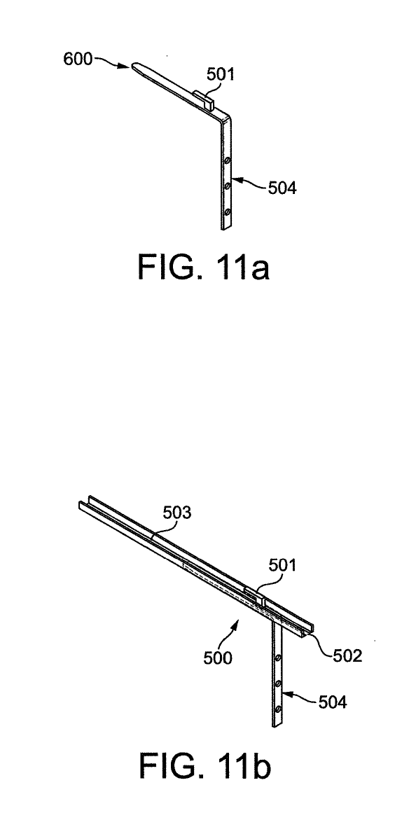

FIGS. 11A and 11B show respective views similar to those of FIGS. 7A and 7B, of a fourth embodiment of apparatus embodying the invention; and

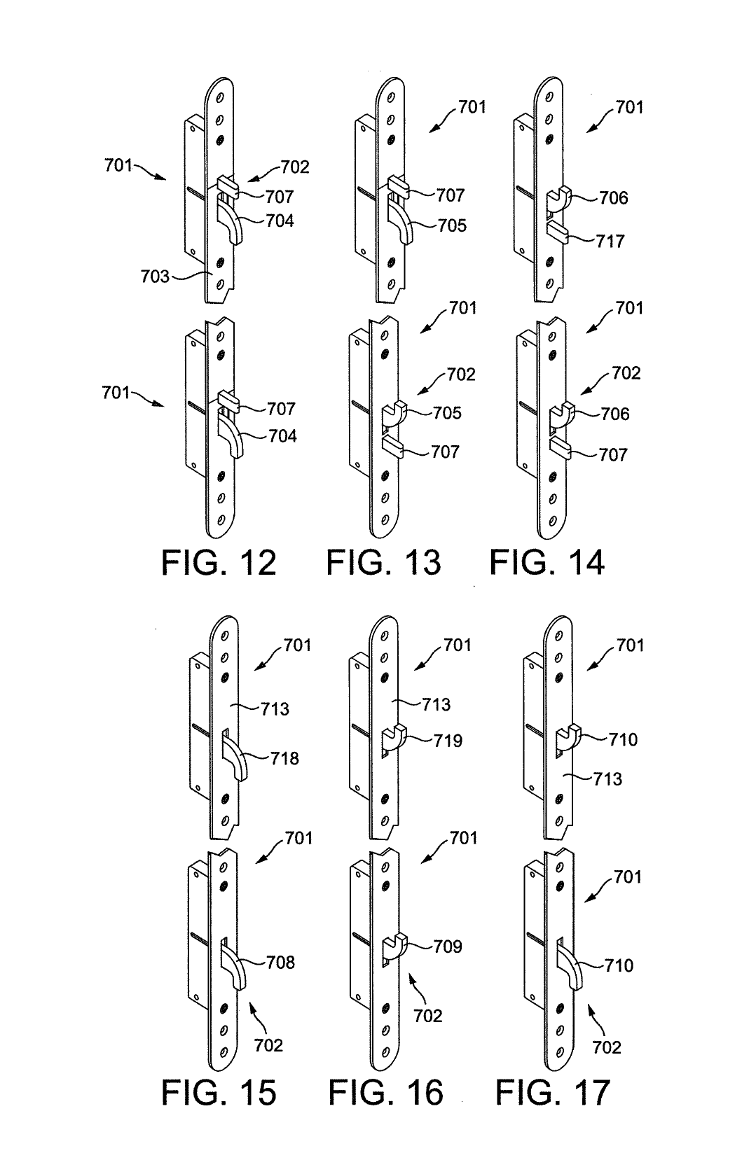

FIGS. 12-29 show schematic perspective views of respective individual embodiments of apparatus embodying the invention, FIGS. 27 -29 further showing to the same scale side elevational views of the respective apparatuses shown.

Referring firstly to FIGS. 1-6B of the drawings, there is shown apparatus 1 for securing together two members such as patio doors 2, 3 which are slidable towards and away from each other as shown by arrow ‘X’ in FIG. 3 to provide a respective open and closed mode, comprising a plurality of devices 4, 5 adapted to secure the members 2, 3 in a closed mode and a control unit 6 adapted to operate the devices 4,5.

In the embodiment shown, there are two spaced apart securing devices 4, 5 and a single control unit 6 situated intermediately of the two securing devices 4, 5. The control unit 6 is connected to an elongate member in the form of a flat connecting rod 7. A rotatable lever 8, FIG. 4a, or a key-operated barrel lock 9, FIG. 4b, are connected to the connecting rod 7 so that on rotation of the lever or key, the rod 7 is shifted longitudinally to operate both securing devices 4, 5 in unison.

The securing devices 4, 5 and control unit 6 are mounted with the connecting rod 7 on a face or stile of one of the patio doors. The facing stile of the other door mounts two keeper units 9, 10 positioned opposite the shifted position of the securing devices so that a hook-like member 11 and an anti-lift device 12 are extended out of the securing devices 4, 5 to engage with the keeper units 9, 10. To achieve this, there is a plate 13 connected to the connecting rod 7 via pins 14, 15 which engage a cover plate in blind slots 16,17,18, 18′, the hook-like member 11 being pivoted at 19 , while the anti-lift device 12 is mounted in a guide for reciprocation orthogonally of the length of the connecting rod 7. The pins 14,15 and blind slots 16,17,18,18′ act as cam and follower means so that on longitudinal movement of the slots to extend the hook-like devices 11 connecting rod 7, the pins ride along their respective slots to extend the hook-like devices 11 and anti-lift devices 12.

The keeper units 4, 5 and the hook-like members 11 have respective complementary sloping surfaces 20 so that any action to try to force the doors 2, 3 apart forces the complementary surfaces together, so hindering the action to try to force the doors apart.

In addition, the anti-lift device 12 is extended simultaneously to enter a facing slot in the keeper unit, so that any attempt to lift the doors 2, 3 apart is prevented.

Longitudinal movement of the connecting rod 7 in the opposite direction retracts the hook-like member 11 and anti-lift device 12 from the keeper unit 6 into the respective securing device, so that the doors 2, 3 can be slid apart.

As described above, there are two sets of hook-like devices 11 and anti-lift devices 12 both sets being driven simultaneously on operation of the intermediately disposed control unit 6.

The connecting rod is suitably covered by a cover strip 21.

Referring now to FIGS. 7A and 7B and 8A and B of the drawings, there is shown embodiments comprising apparatus 100 for providing security for a slidable closure member 200 such as a patio door (FIGS. 8A and 8B) and being adapted to slide in a frame 203 to provide a respective open and closed mode, comprising a keeper element 104 mountable on the frame 203 and a device 105,205 which is adapted to be releasably engageable with the keeper element 104 in the closed mode to maintain engagement of the slidable closure member 200 with the frame 203.

Suitably the apparatus 100 provides security for a slidable closure member having lockable means such as a patio interlock means (not shown) of a patio door 200 and in the closed, locked, mode obviates disruption of the locking means.

The keeper element 104 is a channel section member, downwardly open in use and as shown, which has longitudinally spaced through holes 206 each of which in use receives securing means such as screws 207 which are screwed into the upper horizontal lintel or transom 208 of (the) fixed door frame 203 in relation to which the closure member 200 can slide horizontally between the open and closed, locked, mode.

The device 105,205 in the embodiment has one part 109,209 securable as by screws 210 passed through through holes 110,111 in the part 212 of the door section above the lockable means (not shown in FIGS. 8A and 8B) of the slidable door and a second integral cranked part 113,213 substantially at right angles to the one part 109,209 providing an extension which extends away from the part 212 of the door section. As seen in FIG. 8A the extension 213 is received in a groove 214 in a transom 215 of the door 200 so that the device 205 effectively bridges a mitre joint 216 between the part or stile 212 of the door and the transom 215. The extension 213 butts up against the door frame 208 as shown, FIGS. 8A and 8B.

In use, in the open mode or position of the door 200 the extension 113,213 is remote from the keeper element 104,204. When the door is slidden in the direction of the arrow ‘X’ to the closed mode, the extension 113,213 slides along the underside of the door frame 208 and enters the channel of the keeper element 104,204 as shown in FIGS. 7A and 8A to provide a positive engagement between the door 200 and door frame 208. Stated in another way, the interengagement of the device 105,205 and the keeper element 104, 204 maintains positive location of the part 212 of the door 200 with the transom, lintel or top frame section 215 of the door 200. This positive engagement strengthens the otherwise vulnerable area at the interaction between a locating groove along the transom and a mating ‘upstand’ or depending spigot on the door frame, thereby obviating disruption of the lockable means such as a patio interlock located intermediate the length of the door section below the level of the device 105,205 at the mitre joint or junction 216 (FIGS. 8A, 8B). It will be understood that this junction is vulnerable to being disengaged by the application of force to the top of the door, particularly at its trailing edge, the edge shown in the drawings. Typically the patio interlock includes hooks which are carried on an ‘interlock’ or leading edge section of a slidable door for engaging in seating means in a door frame, or edge of a second door when there are two patio doors.

When the door is in the closed mode, and unlocked, the door 200 can be slid in the opposite direction to the direction ‘X’ to the open position, which action disengages the extension 113,213 from the keeper element 104, 204.

Modifications are possible. Thus FIG. 9 shows apparatus 300 in which there is a device 301 comprising a right angle member for engaging in keeper element 304 of channel section as in FIGS. 7A and 7B. In FIGS. 10A and 10B there is shown a further embodiment 400 in which a keeper element 404 has a blind slot 405 at the end facing the extension 402 of device 401, a right angle member like that 301 of FIG. 9, which extension 402 carries an upstanding pin 403 with a laterally extending or transverse head 406. In use, the upstanding part or shank of the pin 403 is received in the slot 405 with the head 406 extending in sliding engagement between the upstanding limbs of the channel of the keeper element 404 to provide positive interengagement of the keeper element and device in the closed, locked, mode of the door (see FIG. 10B). A yet further embodiment 500 is shown in FIGS. 11A and 11B in which the pin 403 of FIGS. 10A and 10B is replaced by an upstanding hook-like member 501 which in use in the closed, locked, position of the door is received in the slot 502 of keeper element 503 to provide positive interengagement of the keeper element 503 and device 504.

It will be understood too that the keeper element may comprise an element of T-section, suitably being an elongate element, the bar of the ‘T’ being secured to the frame and the (or each) depending shank thereof being adapted to receive in sliding engagement the extension of the device which extension is of channel section.

It will be understood that in all the embodiments of FIGS. 7A to 11B, including the ‘T’ section keeper element and channel shaped extension of the device, the positive interengagement of the keeper element and device in the closed, locked, position of the door obviates disruption of the locking means and maintains the integrity of the door. Stated in another way, the interengagement of parts 104, 105 or 204, 205 prevents the top of the door, particularly at the mitre 216, from being forced away from the frame 208.

As shown, see FIG. 7A, the free or distal end of the extension is tapered to form a nose 600 which facilitates entry of the extension into the channel section keeper element. Also, in a preferred construction, the width of the extension 113,213 is such as to provide a snug sliding fit between the upstanding limbs of the channel section, so as to provide positive interengagement without yawing when the extension and channel section are interengaged.

It will further be understood that the expression ‘closure member’ used herein includes slidable windows as well as doors, particularly but not limited to the larger sliding windows often used in the USA.

The keeper elements and devices 104,105,204,205, and device are suitably made of metal, possibly coated with plastic for ease of interengagement.

Referring to FIGS. 12-29 of the drawings, in which like parts are referred to by like numerals, there is shown apparatus 701 for securing together two closure members such as slidable doors or windows (particularly suitable for patio access) which are slidable towards and away from each other to provide a respective open and closed mode, comprising a plurality of devices 702 adapted to secure the closure members (which are not shown) in a closed mode. It will be understood that all the embodiments include a control unit (not shown in any of FIGS. 12 to 29) like the control unit 6 shown and disclosed hereinbefore and in our co-pending application GB 1421124.7, the disclosure of which is incorporated herein, the control member being adapted to operate the securing devices. The control unit for each embodiment of apparatus can comprise a handle, situated generally centrally longitudinally of the length of the apparatus 701, a motor device such as a solenoid device, an electric or electro-mechanical motor, or spring-loaded interlockable devices.

It is to be noted that FIG. 12 essentially corresponds with FIG. 1 of the drawings and referred to hereinabove, and in co-pending application GB1421124.7.

In the embodiments shown, there are two spaced apart securing devices, an upper one and a lower one as viewed, and a single control unit situated intermediately of the two securing devices. The control unit is connected to an elongate member in the form of a flat connecting rod 703. The control device in each case is connected to the connecting rod so that on operation thereof the rod is shifted longitudinally to operate both securing devices in unison.

The securing devices and control unit are mounted with the connecting rod on a face or stile of one of the closure members, such as patio doors. The facing stile of the other door mounts two keeper units (not shown) positioned opposite the shifted position of the securing devices.

Referring to FIG. 12, the apparatus 701 comprises two securing devices 702 in the form of latch-like or hook-like members 704 which face downwardly. In FIG. 13 the apparatus comprises two securing devices in the form of hook-like members 705 which are opposed, in other words one member faces upwardly (the upper one as viewed) and the other downwardly (the lower one as viewed). FIG. 14 shows an embodiment in which the securing devices are in the form of hook-like members 706 which both face upwardly.

All three of the aforesaid embodiments include anti-lift devices in the form of reciprocable rods 707 extendible and retractable at substantially right angles to the length of the flat (in the embodiments) connecting rod 703.

Referring to FIGS. 15, 16 and 17, in the respective apparatuses 701 hook-like members 708,709 and 710 each face downwardly, upwardly, or are opposed, there being no anti-lift device in these embodiments.

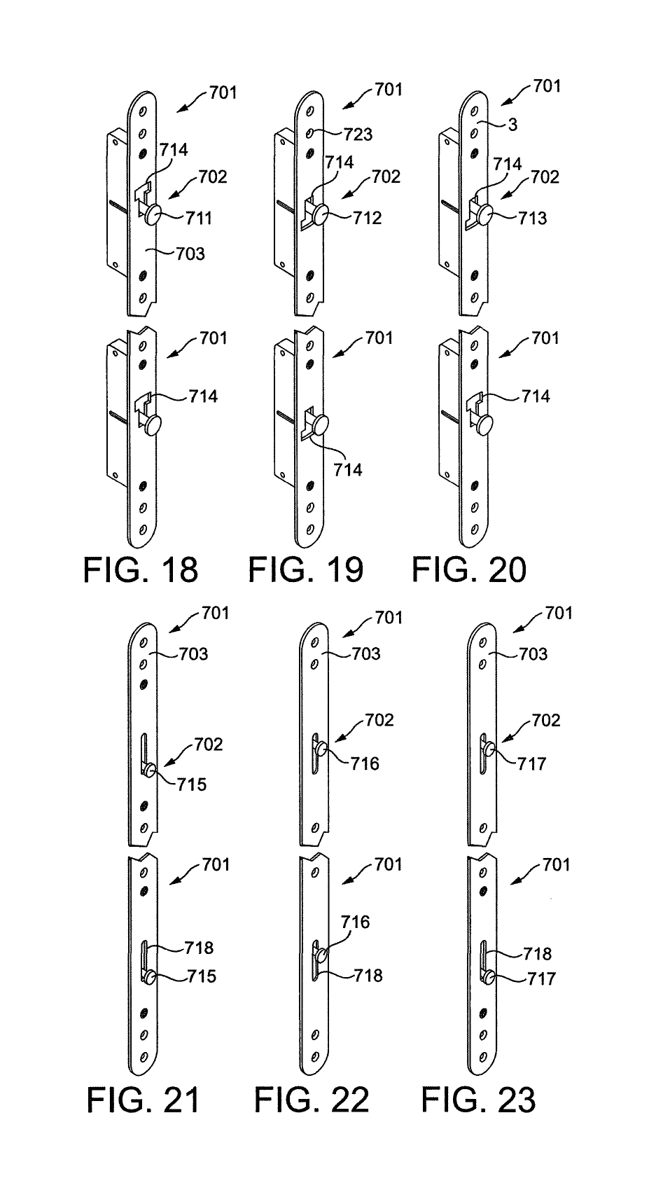

In the embodiments of FIGS. 18, 19 and 20 the respective securing devices comprise pivotable pins 711, 712 , and 713 which protrude through profiled slots 714 through the flat connecting rods, in the embodiments the slots being of T-shape. In FIG. 18 the pins pivot downwardly in use, in FIG. 19 they are pivotable upwardly, and in FIG. 20 they are opposed.

FIGS. 21 to 23 show respective embodiments in which the securing devices comprise fixed pins 715,716 and 717 respectively which extend through elongate blind slots 718 in the connecting rod, in FIG. 21 the pins being up, in FIG. 22 down, and in FIG. 23 being opposed, ie one facing up and one down.

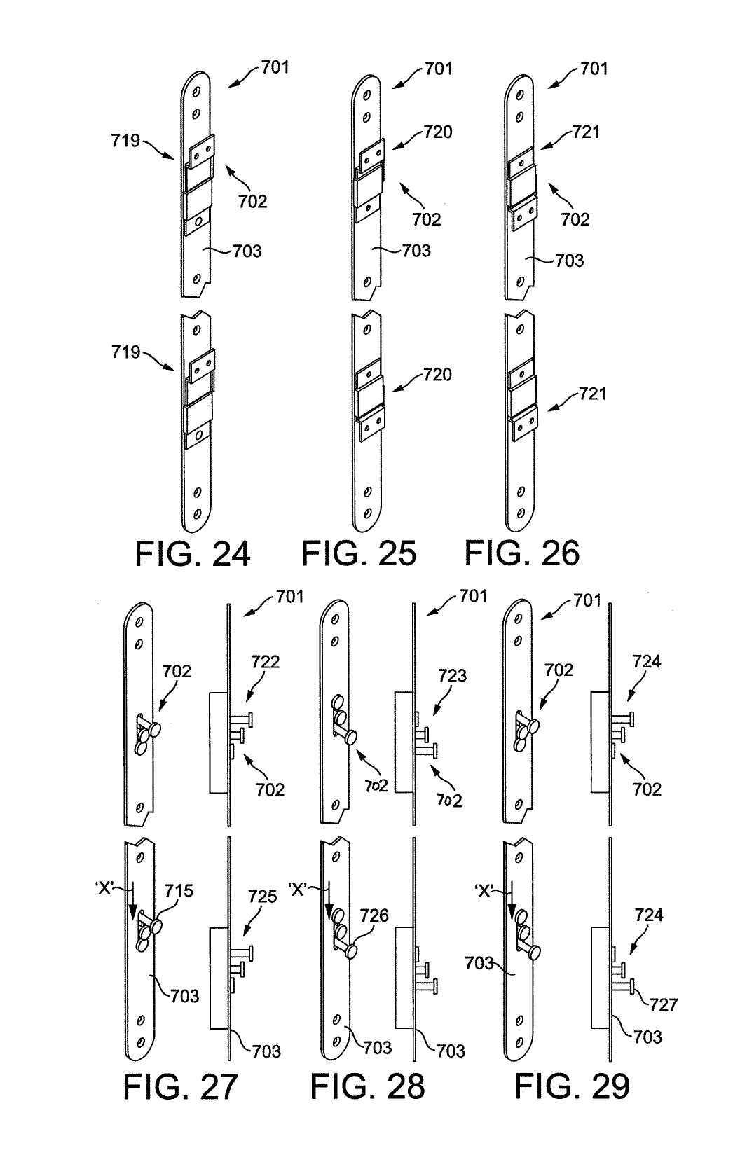

FIGS. 24 to 26 show respective embodiments in which the securing devices 702 each comprise plates or bracket members of L-shape on the connecting rod and which are slidable therewith for engaging and disengaging an opposite keeper on an opposing door. In FIG. 24 the bracket members 719 slide upwardly, in FIG. 25 they are opposing, 20, and in FIG. 26 they slide downwardly, 721.

FIGS. 27, 28 and 29 show three further embodiments respectively in each case being a perspective and side elevational view of a particular embodiment. Common to each embodiment is that the securing devices each comprise a linear pin 722, 723, 724 which has a head 725, 726, 727, the shank of the pin extending through a blind slot in the connecting rod, the pin being adapted to be pulled out away from the connecting rod in the direction of arrows ‘x’ shown in order to engage a keeper on the opposite closure member. In FIG. 27 the upper and lower pins 722 move upwardly and out, in FIG. 28 they move downwardly and out, 723, and in FIG. 29 the pins 724 move in opposed directions, that is the upper pin 724 moves upwardly and the lower pin 724 moves downwardly.

In each embodiment, there is an elongate cover plate having appropriate through orifices aligned with the securing devices secured to the connecting rod.

Using the invention described herein with reference to the drawings, when there is locking means such as a patio interlock means for a patio door, disruption of the locking means in the closed, locked, mode is obviated.

1. Apparatus for securing together two closure members which are slidable within a frame towards and away from each other to provide a respective open and closed mode, comprising
securing devices adapted to secure the members in a closed mode,
a control unit adapted to operate the securing devices,
a keeper element mountable on a lintel of the frame of the apparatus and comprising a channel section member; and
a security device which is adapted to be releasably engagable with the keeper element in the closed mode to maintain engagement of one of the slidable closure members with the frame whereby in use the channel section member is open upwardly and the device comprises a bracket securable to an upper trailing edge of the closure member and an extension that is adapted to be received in the channel section member in the closed mode to thereby provide a positive engagement between the frame and the upper edge of the closure member.

2. Apparatus according to claim 1, comprising two spaced apart securing devices adapted to be mounted on a face or stile of one of the closure members and wherein the control unit is located intermediate the securing devices.

3. (canceled)

4. Apparatus according to claim 2, wherein each securing device comprises a latch member and an anti-lift member.

5. Apparatus according to claim 3, comprising a reciprocably slidable connecting member that connects the two securing devices and the control unit and that actuates the securing devices and between the open and closed modes.

6. Apparatus according to claim 5, wherein the securing devices and the control unit are adapted to be mounted to one of the closure members and the keeper units are adapted to be mounted to the other closure member facing a respective securing device.

7. Apparatus according to claim 6, wherein each latch member comprises a hook-like member.

8. Apparatus according to claim 7, wherein the hook-like members are pivotable between retracted and extended positions by the connecting member.

9. Apparatus according to claim 6, wherein the anti-lift member is movable between retracted and extended positions by the connecting member.

10. Apparatus according to claim 9, wherein the hook-like members and keeper units define complementary sloped surfaces adapted to urge the closure members together in the closed mode.

11. Apparatus according to claim 1, wherein lever means are provided that are adapted to operate the control unit.

12. Apparatus according to claim 1, wherein a key means is provided and adapted to operate the control unit.

13. Apparatus according to claim 7, wherein respective cam and follower arrangements are provided, and the hook-like members and the anti-lift member are operable between the retracted and extended positions by a respective said cam and follower arrangement.

14. (canceled)

15. (canceled)

16. (canceled)

17. (canceled)

18. (canceled)

19. (canceled)

20. Apparatus according to claim 1, wherein the extension is a cranked part of the bracket.

21. Apparatus according to claim 1, wherein the channel section member defines a slot and in that the extension comprises an upstanding member adapted to be slidably received in the slot to provide a positive combination in the closed, locked, mode.

22. Apparatus according to claim 21, wherein the upstanding member comprises a pin with a laterally extending head.

23. Apparatus according to claim 21, the upstanding member comprises a hook-like member a free limb of which extends substantially longitudinally of the keeper element.

24. Apparatus according to claim 1, wherein the extension has a tapered leading end adapted to facilitate entry into the channel section member.

25. Apparatus according to claim 1, wherein the extension and channel section member have a close sliding lateral fit.

26. Apparatus according to claim 1, wherein the extension and channel section member are comprised of metal.

27. (canceled)

28. (canceled)

29. (canceled)

30. (canceled)

31. (canceled)

32. (canceled)

33. A pair of slidable closure members in combination with apparatus according to claim 1.

34. (canceled)
